(19) United States
(12) Patent Application Publication
(10) Pub. No.: US 2019/0020405 A1
(43) Pub. Date: Jan. 17, 2019

(54) SYSTEM AND METHOD FOR OPTIMIZING TRANSMIT POWER MANAGEMENT IN SATELLITE COMMUNICATIONS

(71) Applicant: Kratos Integral Holdings, LLC, San Diego, CA (US)

(72) Inventors: Andrew Smith, Newcastle upon Tyne (GB); Stuart Daughtridge, Huntingtown, MD (US)

(21) Appl. No.: 16/035,366

(22) Filed: Jul. 13, 2018

Related U.S. Application Data
(60) Provisional application No. 62/532,859, filed on Jul. 14, 2017.

(51) Int. Cl. H04B 7/185

(52) U.S. Cl. CPC H04B 7/18513; H04B 7/18515

(57) ABSTRACT

Systems and methods for satellite communications are disclosed. Embodiments of the system can have multiple radio frequency terminals (RFTs), each associated with an antenna. The system can use digital intermediate frequency (IF) versions of analog signals for transmission to a remote ground station via a satellite. Digital IF can allow rapid and efficient switching of signals between connected RFTs in order to select RFT and an antenna pairs having the least interference or highest signal quality. A downlink signal combining unit can use receive diversity from multiple RFTs to determine receive signal quality at each antenna. Signal quality information can be shared with an uplink selector to selectively transmit signals via one or more antennas having the highest signal quality for transmit power management.

### CROSS-REFERENCE TO RELATED APPLICATIONS

This application claims benefit of U.S. Provisional Application No. 62/532,859, filed Jul. 14, 2017, entitled, “SYSTEM AND METHOD FOR OPTIMIZING SATELLITE GATEWAY DIVERSITY,” the contents of which are hereby incorporated by reference in their entirety.

### BACKGROUND

### Technical Field

This disclosure relates to satellite communications. More specifically, this disclosure relates to antenna diversity and optimization in the selection of particular ground stations for transmit and receive operations associated with a transmit signal containing multiple constituent signals or channels.

### Related Art

Ground station diversity or site diversity can provide switching between antenna sites for transmission and reception of satellite signals to avoid weather and equipment failures and optimize efficiency. Digital intermediate frequency (IF) technology can enable fast signal routing and therefore can increase efficient use of ground stations to increase power, link margin, and thus throughput on both the uplink and downlink to and from a satellite.

### SUMMARY

This disclosure addresses systems and methods for satellite communications using downlink site diversity and uplink transmit power management. A plurality of ground stations can have an antenna and a radiofrequency terminal (RFT). The ground stations in the same satellite beam can receive the same signals from a remote ground station via the satellite associated with the satellite beam. A signal processing site (SPS) can receive and combine digitized versions of the signals from the various connected RFTs. This can provide information about channel conditions and signal quality at each antenna/RFT. The SPS can be collocated with one of the RFTs or a separate network entity. The SPS can then receive multiple content streams or data streams for transmission to the satellite. The SPS can route individual signals (including the modulated data stream) to an appropriate RFT based on the channel conditions. This can maximize power amplifier performance, while minimizing signal distortion and intermodulation of multiple signals being transmitted from a single antenna/RFT.

An aspect of the disclosure provides a method for satellite communications in a system having multiple radio frequency terminals (RFTs), each RFT of the multiple RFTs being associated with an antenna and a satellite ground station. The method can include modulating, by one or more modems at a signal processing site (SPS), transmit data as intermediate frequency (IF) signals, each IF signal being a modulated analog signal, the transmit data comprising a plurality of internet protocol (IP) data streams for transmission via a satellite. The method can include receiving an indication of channel conditions for the antenna at each RFT of the multiple RFTs. The method can include selectively coupling, by an uplink selector at the SPS, the SPS to one or more selected RFTs of the multiple RFTs via a digital network based on the indication of channel conditions. The method can include upconverting the IF signals to an operational transmit frequency as uplink subchannels. The method can include transmitting the uplink subchannels to a satellite from the antenna of the one or more selected RFTs.

Another aspect of the disclosure provides a system for satellite communications. The system can have a plurality of antennas for communication with a satellite, each antenna being coupled to a radio frequency terminal (RFT). The system can have a plurality of RFTs, each RFT of the plurality of RFTs communicatively coupled to an antenna of the plurality of antennas. The system can have a signal processing site (SPS). The SPS can have an uplink selector communicatively coupled to the plurality of RFTs in a transmit chain. The SPS can have a combining unit communicatively coupled to the plurality of RFTs in a receive chain. The SPS can have one or more processors communicatively coupled to the uplink selector and the combining unit. The SPS can receive a plurality of receive downlink signals from a satellite via the plurality of antennas. The SPS can combine the plurality of downlink signals at the combining unit to determine a link quality for each downlink signal of the plurality of downlink signals. The SPS can receive transmit data for transmission via the transmit chain to the satellite, the transmit data having multiple IP data streams. The SPS can determine channel conditions for the antenna at each RFT of the multiple RFTs. The SPS can selectively couple the SPS to selected RFTs of the plurality of RFTs by the uplink selector based on the channel conditions. The SPS can transmit the transmit data uplink signals via the selected RFTs.

Another aspect of the disclosure provides a non-transitory computer readable medium in a satellite communications system having multiple radio frequency terminals (RFTs), each RFT of the multiple RFTs being associated with an antenna and a satellite ground station. The non-transitory computer readable medium comprising instructions that when executed by one or more processors cause the satellite communication system to modulate, at one or more modems at a signal processing site (SPS), transmit data as intermediate frequency (IF) signals, each IF signal being a modulated analog signal, the transmit data comprising a plurality of internet protocol (IP) data streams for transmission via a satellite. The instructions can also cause the satellite communications system to receive an indication of channel conditions for the antenna at each RFT of the multiple RFTs. The instructions can also cause the satellite communications system to selectively couple the SPS to one or more selected RFTs of the multiple RFTs via a digital network based on the indication of channel conditions. The instructions can also cause the satellite communications system to upconvert the IF signals to an operational transmit frequency as uplink subchannels. The instructions can also cause the satellite communications system to transmit the uplink subchannels to a satellite from the antenna of the one or more selected RFTs.

### BRIEF DESCRIPTION OF THE FIGURES

The details of embodiments of the present disclosure, both as to their structure and operation, may be gleaned in part by study of the accompanying drawings, in which like reference numerals refer to like parts, and in which:

FIG. 1 is a graphical depiction of an embodiment of a system for communications between a satellite and plurality of ground stations using satellite antenna diversity;

FIG. 2 is a graphical representation of another embodiment of a system for communications between a satellite and plurality of ground stations using satellite antenna diversity;

FIG. 3 is a functional block diagram of components of a communication device that may be employed within the communication system of FIG. 1 and FIG. 2

FIG. 4 is a flowchart of a method for satellite communication using the system of FIG. 2;

FIG. 5 is a flowchart of a method for satellite communication using the system of FIG. 2;

FIG. 6 is a graphical representation of transmit data transmitted via the system of FIG. 2;

FIG. 7 is a graphical representation of downlink signals transmitted via the system of FIG. 2; and

FIG. 8 is a graphical representation of uplink signals transmitted via the system of FIG. 2.

### DETAILED DESCRIPTION

The detailed description set forth below, in connection with the accompanying drawings, is intended as a description of various embodiments and is not intended to represent the only embodiments in which the disclosure may be practiced. The detailed description includes specific details for the purpose of providing a thorough understanding of the embodiments. In some instances, well-known structures and components are shown in simplified form for brevity of description.

Antenna or site diversity can be used to switch between transmission and reception sites to avoid or mitigate signal degradation, for example, from weather, and/or equipment failures. Antenna diversity, space diversity, spatial diversity, or site diversity, as referred to herein can use one or more of several wireless diversity schemes using two or more antennas to improve the quality and reliability of a given wireless communication link.

Antenna or site diversity can take advantage of reception of a signal at multiple antennas within a coverage region. Downlink communications from the satellite can be improved by combining multiple iterations of digitized IF signals. Similarly, uplink communications can be improved by using digital IF to route signals among multiple antennas to optimize use of diverse amplifier/antennas systems for transmission.

Antenna diversity can be effective for mitigating weather, local interference, and other impacts to signals for both the uplink and downlink. This is because multiple antennas enable several observations of the same signal to be received at different antennas and combined. Each antenna can experience different weather and interference environments. Thus, if one antenna is experiencing a deep fade, it is likely that another has a sufficient signal. Collectively, such a system can provide a robust link. While this is primarily seen in receiving systems (diversity reception), the same has also proven valuable for transmitting systems (transmit diversity) as well. Multiple antennas can provide more than just receive diversity, but performance improvements when antennas are not impaired. In an exemplary two-antenna arrangement, some diversity implementations have a primary antenna and one backup antenna. An exemplary benefit of embodiments described herein provide twice the uplink and downlink throughput when both antennas have clear skies and drop back to normal performance when bad weather. As esribed below, management of the amplifiers can match or exceed the gains of the downlink signal combining.

In satellite communications, multiple ground stations can be used to transmit and receive various transmissions and benefit from the use of geographic site diversity to increase reliability and avoid adverse effects of rain fade, for example.

In some embodiments disclosed herein, site diversity can be implemented using digital IF technology to allow more efficient use of satellite ground stations to increase power, link margin, and data throughput on both the uplink to a satellite and downlink from the satellite. In the disclosed embodiments, downlink communications can be improved by combining receiver digitized IF signals from multiple antennas. Uplink communications can be improved by using digital IF to route signals among ground stations and optimize the use of a plurality of amplifiers associated with different ground stations. Advantageously, digital IF routing provides precise timing and extremely fast switching between sites to maximize throughput and minimize the impact in data loss from a switching event.

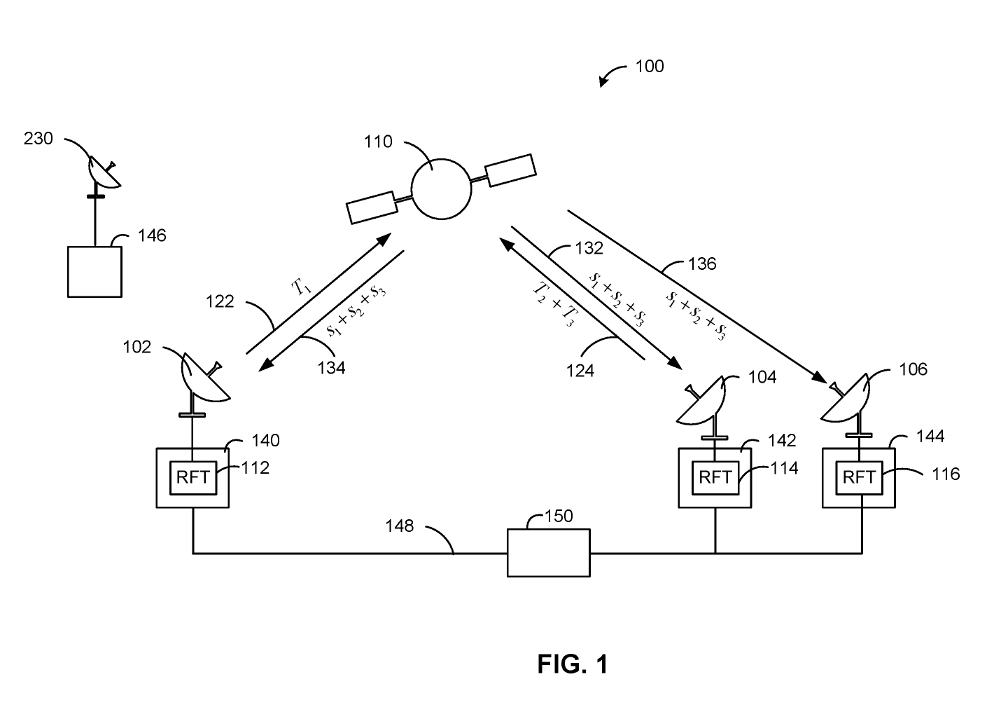

FIG. 1 is a graphical representation of an embodiment of satellite communications between a plurality of ground stations. A communication system (“system”) 100 includes a plurality of ground stations 140, 142, 144, 146 communicating with one another via a satellite 110. In some embodiments, the communication system 100 may comprise more than three ground stations 140, 142, 144, 146 shown and more than one satellite 110. The ground stations 140, 142, 144, 146 may generally be geographically separated. The ground stations 146 is shown further away from the ground stations 140, 142, 144 as may be referred to herein as a distant ground stations 146. In some example, the ground stations 140, 142, 144 may be geographically separated but still within the same satellite beam.

The ground station 140 may transmit a signal 122 (T₁) to the satellite 110 that is then relayed to the ground stations 142, 144. The ground station 142 may transmit two signals 124 (T₂+T₃) to the satellite 110 that are relayed to the ground station 140 and the ground station 144. The ground station 140 may receive the signals 124 (T₂+T₃) and an echo of its own transmitted signal 122 (T₁) as a composite signal 134 (shown as, S₁+S₂+S₃). Similarly, the ground station 142 may receive the signal 122 (T₁) and an echo of its own transmitted signals 124 (T₂+T₃) as a composite signal 132 (shown as S₁+S₂+S₃). As used in FIG. 1, the “T” indicates a transmitted signal while the “S” indicates a corresponding signal received at one or more of the ground stations 140, 142, 144. The ground station 144 does not transmit a signal of its own.

The signal 122 (T₁) and the signal 124 (T₂) together, as received by the ground station 144, is referred to as a composite signal 136. The composite signal 136 may be similar to the composite signal 132 and the composite signal 134, being a combination of three signals, S₁+S₂+S₃. In some embodiments, either or both of the signal 122 and the signals 124 can be signals of interest for the ground station 144. In some embodiments, the ground station 144, in addition to the ground stations 140, 142 can implement certain interference mitigation or signal separation methods in order to extract signal(s) of interest from the received composite signal 136 or the signals 132, 134. Some such interference mitigation or signal separation methods may be those disclosed by U.S. Pat. No. 9,219,631 and U.S. Pat. No. 9,130,624, both of which are hereby incorporated by reference in their entirety.

Each of the ground stations 140, 142, 144, 146 can have a radiofrequency (RF) terminal (RFT) and one or more antennas. The systems/equipment from the antennas to digital IF units for both the up and downlink chains collectively can be referred to as an RFT. The size of the antennas and the capabilities of the RFT may or may not be the same. In some examples, one RFT can have a corresponding antenna. For example, the ground station 140 can have an antenna 102 and an RFT 112. The ground station 142 can have an antennas 104 and an RFTs 114. The ground station 144 can have an antenna 106 and an RFT 116. The distant ground station 146 can have an antenna 230. Each of the ground stations 140, 142, 144 can be communicatively coupled together via a terrestrial network 148. The terrestrial network 148 can be the Internet, for example. In some embodiments, the distant ground station 146 may not be coupled to the terrestrial network 148. In some other embodiments, the distant ground station 146 may be coupled to the terrestrial network 148.

The system 100 can further have a signal processing site (SPS) 150. The SPS 150 can have one or more processors, modems, switches, and other electronic or electrical equipment that can perform signal combining, signal switching, and other signal processing tasks as described herein.

In some embodiments, the SPS 150 can switch one or more signals between the RFTs 112, 114, 116 to optimize uplink power margins and avoid transmitting in suboptimum conditions (e.g., weather, antenna malfunctions, etc.). In some embodiments, the SPS 150 can be a standalone system. The SPS 150 can also be collection of subsystems that is coupled to the ground stations 140, 142, 144 via the terrestrial network 148. In some other embodiments, the SPS 150 can be collocated with one of the ground stations (e.g., the ground station 144), and transmit/receive signals from one or more of the connected ground stations 140, 142, 144.

Each of the ground stations 140, 142, 144, 146 can have certain devices such as upconverters, downconverters, modems, or multiple processors, for example, capable of transforming and encapsulating or otherwise encoding raw satellite communication transmissions for transmission over a digital network. In some examples, the ground stations 140, 142, 144, 146 can encode the raw signals in a downconverted form without decoding the information in the signal for packetized transfer via internet protocol (IP) communications. For example, the signal 132 can be received at the antenna 104, downconverted to IF, digitized (e.g., encapsulated), and sent via the terrestrial network 148 to one of the other connected ground stations, 140, 144.

Such systems can be referred to as digital IF systems. Digital IF is a process for digitizing a signal at IF (Intermediate Frequency) or radiofrequency (RF) and sending the signal via internet protocol (IP) packets over a digital or packet switched network, and then either reconstituting the original signal or processing the signal from the packetized in-phase and quadrature (I/Q) representation of the analog RF data. In this regard, digital IF systems can be signal transport systems over IP networks. The received analog RF signal can be converted to an IF digital format, and transmitted, reformatted, combined with other signals, and/or routed in ways (e.g., via a packet switched network) not otherwise compatible with analog signals alone. The analog signals can then be faithfully reconstructed from the digital data stream. In such systems the digital IF information may not contain decoded or demodulated information from the related RF signals. That is, portions of the signal are captured and encoded/encapsulated for transport via a packet switched network, but the data modulated on the analog signal is not demodulated or decoded. Some such IF packetized data transmission methods and systems may be those disclosed by U.S. Pat. No. 9,577,936, which is hereby incorporated by reference in its entirety

The composite signal 136 may be subject to different forms and levels of interference than the signal 132 and the signal 134 due to different operating environments affected by, among other things, weather patterns, geographic features, etc. In some embodiments the composite signals 132, 134, 136 may further encounter varying amounts of interference. In other embodiments, the one or more signals 122, 124 found within the composite signals 132, 134, 136 may also be referred to herein as constituent signals. Two modulated signals transmitted together may also be considered an additional modulation, also referred to herein as an intermodulation. Thus, for example, the signal 122 and the signals 124 may be referred to as constituent signals of the composite signal 136. An intermodulation can have two or more signals modulated together.

Intermodulation can occur when a plurality of signals is amplified and mix together. In order to prevent intermodulation, the amplification of one or more of the constituent signals may be reduced (e.g., power backoff). For example, when amplifying multiple signals together, the power may be reduced (by e.g., 2 dB or more) in order to reduce the instance or effects of intermodulation. In general, as additional signals are amplified together, further back off may be necessary to limit the effect of intermodulation until the amplifier is well into its linear region of operation.

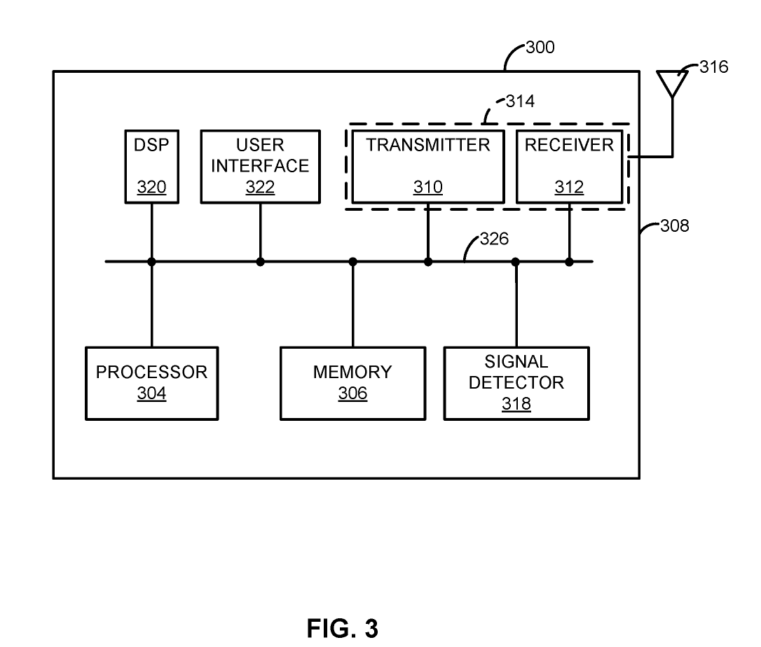

In some embodiments, in order to maximize the use of the available frequency spectra, the signal 122 and the signals 124 may use the same or similar bandwidth. In some embodiments, the signal 122 and the signals 124 may have the same amplitude. In some other embodiments, the signal 122 and the signals 124 may differ slightly in one or more of bandwidth, phase, and amplitude. Accordingly, the ground stations 140, 142 may accidentally or intentionally utilize similar frequencies, bandwidths, and power levels (e.g., amplitude) to transmit their respective signals (T₁, T₂, T₃) for example, the signal 122 and the signals 124. Thus, the ground station 144 may receive the signal 122 and the signals 124 having a significant or complete frequency overlap between the received signals. In some embodiments, there may be more than two overlapped signals. The overlap of two or more signals of interest may present the ground station 144 with certain problems requiring separation and parsing of overlapped and possibly interfering signals, for example the signal 122, and the signals 124. However ground stations (e.g., the ground station 142 having multiple antennas 102, 104, 106, 316 of FIG. 3) can implement antenna diversity and signal combining to, for example, increase SNR and optimize signal reception.

Modulation as described herein may include, but not be limited to analog or digital modulation. Some of the modulation schemes referenced herein can include but not be limited to quadrature amplitude modulation (QAM), phase shift keying (PSK), binary PSK (BPSK), quadrature PSK (QPSK), differential PSK (DPSK), differential QPSK (DQPSK), amplitude and phase shift keying (APSK), offset QPSK (OQPSK), amplitude shift keying (ASK), minimum-shift keying (MSK), Gaussian MSK (GMSK) among other types of modulation, time division multiple access (TDMA), code division multiple access (CDMA), orthogonal frequency division multiple access (OFDMA), and continuous phase modulation (CPM). Certain modulation types such as for example QAM and APSK may also differ in modulus, for example, 4QAM, 8QAM, and 16APSK, to name a few.

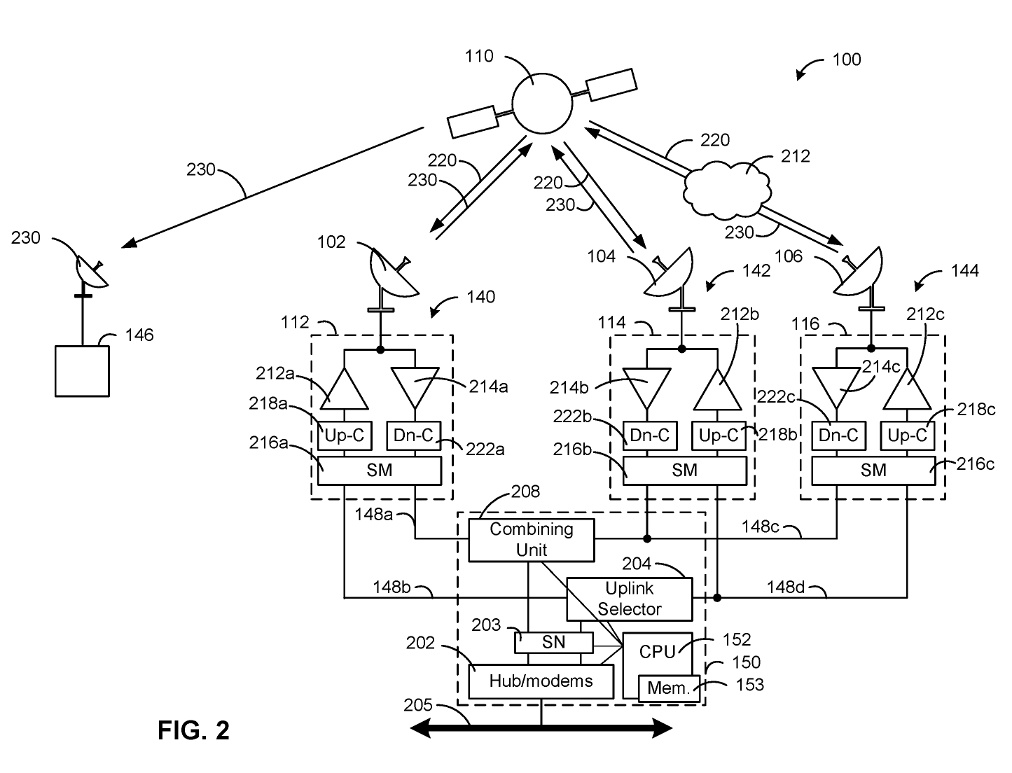

FIG. 2 is a functional block representation of an embodiment of the system of FIG. 1 using satellite antenna diversity and transmit power management. Antenna diversity or site diversity, as related to satellite communications, can leverage multiple antennas at different geographical locations, but all within the same beam coverage from the satellite 110, to maximize transmit opportunities and minimize interference or attenuation caused by various environmental or various operational factors. The ground stations 140, 142, 144 may be in the same satellite beam, while the distant ground station 146 may be in the same or a different satellite beam. In some embodiments, the antenna/RF systems can implement digital IF technology to allow physical or geographic separation between the antenna/RF systems and the signal processing (hub/modem) systems. In addition, received signal strength can also be improved by using the multiple antennas and signal combination at the digital IF packet level.

The SPS 150 can have can have a transmit chain and a receive chain communicatively coupled to the RFTs 112, 114, 116. The transmit chain and the receive chain can share certain components. For example, in the transmit chain, the SPS can have a hub 202, a signal modifier 203 and an uplink selector 204. In the receive chain, the SPS 150 can have a combining unit 208, the signal modifier 203, and the hub 202. The SPS 150 can also have a processor 152 (labeled as CPU 152) and an associated memory 153. The processor 152 can be implemented as one or more processors or microprocessors and can function as a central processing unit (CPU). The processor 152 can further be coupled to the hub 202, the signal modifier 203, the uplink selector 204, and the combining unit 208. For ease of description, the various components are described herein as performing specific functions associated with transmission and reception and processing of signals in the SPS 150. However in some embodiments the processor 152 may actually perform the described function.

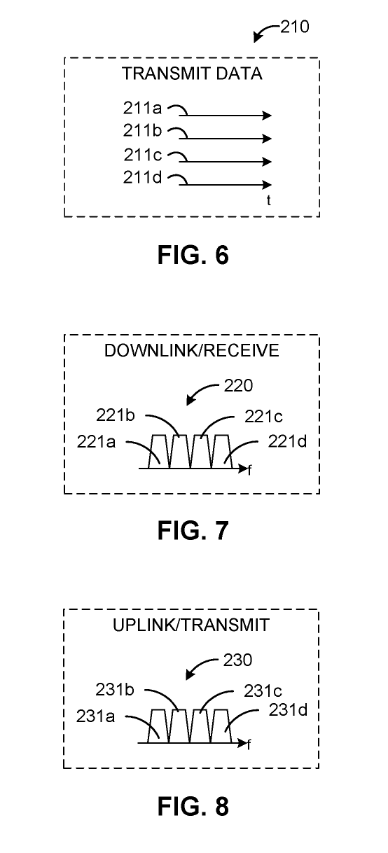

In the following description of FIG. 2, reference is made to FIG. 6, FIG. 7, and FIG. 8.

FIG. 6 is a graphical representation of transmit data transmitted via the system of FIG. 2. Transmit data 210 can be any data that is to be modulated and transmitted via the system 100 and the satellite 110. The transmit data 210 can be Internet Protocol (IP) data, such as TCP/IP data, from the Internet or other applicable network, for example. The transmit data 210 can have one or more transmit data subchannels 211a, 211b, 211c, 211d (collectively transmit data subchannels 211). Each of the transmit data subchannels 211 can represent an individual content stream. The transmit data subchannels 211 can be four (or more) separate IP data streams that are to be modulated and transmitted to the satellite 110. For ease of description, four arrows are used to represent four transmit data subchannels 211 and their respective data streams. The transmit data 210 can have more or fewer than four data streams. Time (t) is represented by the horizontal axis.

FIG. 7 is a graphical representation of downlink signals transmitted via the system of FIG. 2. A downlink signal 220 can have modulated data received at one or more of the ground stations 140, 142, 144. The downlink signal 220 can have multiple downlink subchannels 221 (labeled as 221a, 221b, 221c, 221d). The downlink subchannels 221 may also be referred to herein as downlink signals 221. The downlink signal 220 and the downlink subchannels 221 can be transmitted by a remote ground station (e.g., the remote ground station 146) or from different remote ground stations or some combination thereof. In the receive chain, the downlink signal 220 and the downlink subchannels 221 more particularly, can be received, downconverted to IF, and digitized. Using signal diversity, multiple of the antennas 102, 104, 106 can receive the same downlink subchannels 221, and determine certain channel state information or transmission channel quality can be gleaned from digital combination of the digital IF versions of the downlink subchannels 221. This is described in more detail below. For ease of description, the downlink subchannels 221 are represented in FIG. 7 as four adjacent signals in the frequency (f) domain. Frequency is shown on the horizontal axis, while amplitude is vertical. The downlink subchannels 221 are shown separated in frequency for ease of description, however the downlink subchannels 221 may be overlapped in one or more of frequency and amplitude.

FIG. 8 is a graphical representation of uplink signals transmitted via the system of FIG. 2. An uplink signal 230 can have modulated data (e.g., the transmit data 210) intended for reception at a distant location, via the satellite 110. The uplink signal 230 can have multiple uplink subchannels 231 (labeled as 231a, 231b, 231c, 231d). The uplink subchannels 231 may also be referred to herein as uplink signals 231. Each of the uplink subchannels carries a modulated version of a corresponding transmit data subchannel 211. Thus in some embodiments, each of the uplink subchannels 231 can have a content stream corresponding to the associated data subchannel 211. For example, the SPS 150 can transmit the uplink signal 230 via one or more of the RFTs 112, 114, 116. In some embodiments, the SPS 150 can switch different uplink subchannels 231 via one or more of the RFTs 112, 114, 116 based on downlink channel (e.g., environmental) conditions at a given RFT. For ease of description, the uplink subchannels 231 are represented in FIG. 8 as four adjacent signals in the frequency (f) domain. Frequency is shown on the horizontal axis, while amplitude is vertical. The uplink subchannels 231 are shown separated in frequency for ease of description, however the uplink subchannels 231 may be overlapped in one or more of frequency and amplitude. The uplink subchannels 231a, 231b, 231c, 231d can be all being transmitted to remote terminal 146 or different remote terminals, or multiple remote terminals, or some combination thereof.

### Receive Chain

Referring again to FIG. 2, the RFTs 112, 114, 116 can each have a low noise amplifier (LNA) 214 (shown as LNAs 214a, 214b, 214c) communicatively coupled to the antennas 102, 104, 106 in the receive chain. In some examples, the downlink signal 220 and/or one or more of the respective downlink subchannels 221 can be received at the antennas 102, 104, 106, from the remote ground station 146 via the satellite 110. The LNAs 214 can amplify the downlink subchannels 221 received at the antennas 102, 104, 106 from the satellite 110.

The RFTs 112, 114, 116 can have downconverters 222 (labeled as Dn-C 222a, Dn-C 222b, Dn-C 222c) coupled to the LNAs 214. The downconverters 222 can downconvert the downlink signal 220 (e.g., the downlink subchannels 221) to IF bands for heterodyne reception. In the receive chain, the downconverters 222 can be coupled to signal modifiers 216 (labeled as signal modifiers 216a, 216b, 216c). The signal modifiers 216 can digitize or encapsulate the IF signals and packetize the analog IF signals as digital IF signals. The encapsulation can include sampling the amplified and downconverted downlink subchannels 221 (e.g., the analog IF signals) at a high rate, and then transmitting the sample data as packets over a packet switched network such as the terrestrial network 148. Each signal modifier 216 can perform both the functions of packetizing digitized analog signals (in the receive chain) and reconstituting the analog signal from digital packet data (in the transmit chain).

In some embodiments, the received RF energy (e.g., the downlink subchannels 221) can be digitized directly without upconverters and downconverters to and from IF. In embodiments having very fast sampling at the uplink selector 204 (see below), for example, the I/Q data may be handled directly and IF may not be required. In such an embodiment, the downconverters 222 and the upconverters 218 (see below) may not be present.

The signal modifiers 216 can be coupled to the SPS 150 via the terrestrial network 148. The SPS 150 can have a combining unit 208. The combining unit 208 can be coupled to and receive instructions from the processor 152. In some embodiments, the combining unit 208 can receive all of the different versions of all incoming downlink signal 220 (and downlink subchannels 221) from all of the RFTs 112, 114, 116 to combine the signals to increase the received signal-to-noise ratio. Alternatively, the functions of the combining unit 208 can be performed by the hub 202.

The combining unit 208 can digitally combine the amplified, downconverted, and digitized downlink subchannels 221 (received from the signal modifiers 216) to maximize the combined SNR and enhance data throughput and resiliency of the network. In some embodiments, the combining unit 208 can measure the incoming digitized signals, to determine various characteristics (e.g., frequency, amplitude, phase, etc.) align them in frequency and phase, and digitally combine them to maximize the combined signal SNR and thus maximize the data throughput. This can be performed in real-time. The real-time measurements of the incoming signals are also used to understand impact of weather 212 and other related conditions that impact signals transmission. The uplink selector 204 (or, e.g., the processor 152) can use such channel information to optimize the uplink performance in response to the real-time conditions as measured by the combining unit 208. The impact assessment on the signals can determine where the signals are being impacted, whether on the uplink to the satellite or the downlink from the satellite to the antenna based on which of uplink subchannels 231 will experience the impact. The processor 152 and the uplink selector 204 can implement this information to switch transmit subcarriers or different signals between the PAs 212/antennas 102, 104, 106 pairs to maximize the system performance based on real-time link conditions.

In some examples, if all of the downlink subchannels 221 are received at the antennas 102, 104, 106 and only the antenna 106 has a degraded SNR on all of the subchannels, then it may be concluded that weather 212 is attenuating or otherwise affecting the signals received at the RFT 116. In another example, if the RFTs 112, 114, 116 are sufficiently geographically separated, and the SNR of some or all of the downlink subchannels 221 received at all of the antennas 102, 104, 106 are degraded, that can reveal information about the quality of the link conditions from the remote ground station 146, assuming some or all of the subchannels 221 are coming from that site.

The SPS 150 can have a signal modifier 203 interfaced or otherwise communicatively coupled to the combining unit 208. The signal modifier 203 can be similar to the signal modifiers 216. The signal modifier 203 can reconstitute analog IF versions of each of the downlink subchannels 221 from the combined digital, packetized versions of the signals received from RFTs 112, 114 and 116. These analog IF versions of the signals (e.g., the downlink subchannels 221) are functionally the same signals and contain the same information as the downconverted downlink subchannels 221 with higher SNR via the combining process.

The signal modifier 203 can be coupled to the hub 202. The hub 202 can have one or more associated modems, signal processing systems, and other computing systems configured to, for example, convert the analog IF version of the downlink subchannels 221 into IP data streams (e.g., TCP/IP data) for transport via a larger backbone 205. The backbone 205 can be the Internet or other wide area network (WAN).

### Transmit Chain

The transmit chain can include components (e.g., a power amplifier) and circuitry for conveying transmit data 210 (FIG. 6) to the satellite 110 from multiple antennas using intelligent transmit power management. In some embodiments, the uplink signal 230 can originate at the SPS 150 based on modulated transmit data 210. The transmit data 210 can be transformed a number of times by components of the transmit chain for efficient switching, routing, and transmission from the SPS 150 to the RFTs 112, 114, 116. The transmit data subchannels 211 can be transformed and transported individually between the SPS 150 and the selected RFTs as digital IF data streams and then converted back to an analog signal, upconverted, and amplified prior to transmission as the uplink subchannels 231 to the satellite 110 via the associated antenna.

In the transmit chain, the hub 202 can transform, or otherwise modulate, the transmit data 210 (e.g., the transmit data subchannels 211) into modulated analog signals (e.g., modulated data on a carrier signal). The hub 202 can be configured to, for example, convert embedded IP data streams (e.g., the transmit data 210 or TCP/IP data) received from the backbone 205 into analog IF signals in the transmit chain.

In some embodiments, the hub 202 can receive the transmit data 210 as internet protocol (IP) packet data (data streams) from the backbone 205 for transmission via the ground stations 140, 142, 144 to the satellite 110. Each of the data streams 211 can, through the methods disclosed herein, become an uplink subchannel 231. The transmit data 210 can arrive at the hub 202 as TCP/IP packets, or other types of packet or IP data. The hub 202 can, via one or more modems in the hub 202, modulate the transmit data 210 into one or more analog signals. In some examples the analog signals can be a modulated IF signal, such as L-band.

The hub 202 can be interfaced or otherwise communicatively coupled to the signal modifier 203, similar to the signal modifiers 216. The signal modifier 203 can convert the analog signal into digitized packets or otherwise encapsulate the analog signal for transmission as network packets. This can result in the digital IF form of the transmit data 210. The network packets can be easily switched between the coupled RFTs 112, 114, 116. As with the signal modifiers 216, the encapsulation can include sampling analog signals (e.g., the IF signals) at a high rate, and then transmitting the sample data as packets over a packet switched network. On the receiving end, the packet data can be reformed into the original analog signal with minimal loss. Each signal modifier 203 can perform both transmit (packetizing digitized analog signals) and receive (reconstituting the analog signal from digital packet data) functions. This digital IF transformation can allow fast and efficient sourcing for site diversity between the SPS 150 and RTFs 112, 114, 112, such that the switching of signals to optimize performance causes minimal bit errors.

The signal modifier 203 can be coupled to the uplink selector 204. The uplink selector 204 can be coupled to and receive instructions from the processor 152. The uplink selector 204 can further be coupled to the RFTs 112, 114, 116 via portions of the terrestrial network 148. Different portions of the terrestrial network 148 are labeled with letters indicating separate portions, such as the terrestrial network portions 148a, 148b, 148c, 148d. The uplink selector 204 can then switch between ground stations 140, 142, 144 (or more particularly, the RFTs 112, 114, 116) to provide the digital IF form of the transmit data 210 as portions of the uplink signal 230 (e.g., the uplink subchannels 231) to one or more of the coupled RFTs to optimize the performance of the amplifiers (e.g., the PAs 212) given the signal conditions. In some embodiments, the signal modifier 203 may not be present, whereby the hub 202 is coupled directly to the uplink selector 204 and the IF data is transmitted as analog signals over fiber on dedicated networks. Alternatively, functions of uplink selector 204 can be performed by the hub 202.

In some embodiments, the uplink selector 204 can perform switching of the digital IF version of the transmit data 210 (e.g., the uplink subchannels 231) for transmission via one of the RFTs 112, 114, 116 within the transmit chain. This can maximize performance of the amplifiers (e.g., the PAs 212) on the uplink so that a limited number of the uplink subchannels 231 are transmitted per RFT/antenna. This can minimize the number of signals transmitted via a given amplifier to maximize the amplification power provided per signal and reduce the amount of power back-off required in the amplifier (PAs 212) to limit the size of the intermodulations signals created by amplifying multiple signals in the same amplifier (e.g., the PAs 212). For example, if an amplifier is transmitting one carrier (e.g., the uplink subchannel 231a) and operating at full power with no intermodulation distortion (IMD) created, then with X Watts of power available (where X the maximum rate power of the amplifier), all of the power is available to transmit the single carrier or signal/subchannel. If the RFT is transmitting two carriers (e.g., the uplink subchannel 231a, 231b), only (X−Y)/2 Watts are available for each carrier (where Y is the back-up required to limit intermodulation distortion), reducing the link margin and therefore the link availability. As the number of carriers or signals per RFT increases, the backoff required (Y) also increases. In another example, it might be optimum because of the data throughput needs of the signals and the RFT capabilities that under clear sky and perfect equipment operating conditions to have uplink subchannels 231a, 231b be transmitted through RFT 114, have uplink subchannel 231c transmitted through RFT 114, and have uplink subchannels 231d transmitted through RFT 116.

Thus, in some embodiments, it may be beneficial and most efficient to transmit only a single uplink subchannel 231 via a single RFT. In such an embodiment, there may be an equal number of uplink subchannels 231 to RFT-antenna pair. Thus, in the primary example of FIG. 2, only three RFTs are present while there are four uplink subchannels 231. However any combination is possible as long as there is more than one RFT and more than one subcarrier or uplink subchannel 231.

The SPS 150 can, via the uplink selector 204, switch the digital IF stream relating to each subcarrier or uplink subchannel 231 between the various RFTs 112, 114, 116 and the corresponding antennas 102, 104, 106. The antennas 102, 104, 106 can be, for example, a number of smaller antennas, rather than a single large antenna, or even antennas of different size and RFTs of different performance levels. This may be valuable because the cost of the RFT can increase with the size of the antenna and the size of the amplifiers. As described herein, using transmit power management, a single large antenna can be replaced by multiple smaller antennas while increasing efficiency, signal fidelity, signal resilience to weather (and other system-level problems such as component failure), and (data or communication) throughput. Accordingly, having multiple smaller antenna and amplifier systems can in many cases reduce cost of implementation over deployment of a single large antenna and amplifier system.

In some embodiments, the processor 152 can receive information related to various environmental factors at the antennas 102, 104, 106 from the combining unit 208. For example, as the downlink signal 220 is received at the antennas 102, 104, 106, the SPS 150 (e.g., the processor 152) can determine variations in the SNR of each version of the downlink subchannel 221 or the whole downlink signal 220 received. In one example, if the version of the downlink signal 220 received at the antenna 106 is degraded in comparison to versions of the downlink signal 220 received at the other antennas 102, 104, then the assumption can be made that there reception issues at the antenna 106, perhaps caused by the weather 212. As a result, it can then be known that the uplink capability of the RFT 116 and the antenna 106 may be degraded. As a result, SPS 150 can optimize signal routing and amplifier settings to maximize the system throughput, and prioritize the priority or at least more important traffic in spite any system degradation due to weather or component failure. If, on the other hand, some or all of the received versions of the downlink signal 220 have a degraded SNR or quality (e.g., only those transmitted from remote ground station 146), then it can be surmised that the transmission from the remote ground station 146 that could have the issue, such as a weather related degradation in performance. In a complex network, with two or more RFT sites being combined/coordinated to provide the hub/gateway earth station capability communicating with 100s or even 1000s of remote terminal sites, it can be seen how this real-time status information on the link performance from weather and other environmental impacts can be used to optimize the network performance.

Based on information gleaned from the reception quality of one set of downlink signal 230 at the antennas 102, 104, 106, the uplink selector 204 (e.g., the processor 152) can route digital IF signals an appropriate RFT 112, 114, 116 to maximize performance. In some embodiments, this can be performed in near-realtime. Such environmental factors such as weather 212 can affect the downlink signal to noise ratio and uplink path loss of the uplink signal 230. Accordingly, the uplink selector 204 can determine, based on the reception characteristics of the downlink signal 220 and respective downlink subchannels 221, which is the optimum RFT/antenna for transmitting each of the uplink subchannels 231. This can maximize the throughput of the entire system 100 and/or ensure the throughput of the highest priority signals. Alternatively, this can be a function performed by the hub 202 or a related network management or traffic management system. In some embodiments, there may be a single RFT selected for each uplink subchannel 231, for example, under clear sky conditions. In this way, all the useable power from the uplink amplifier (e.g., the PAs 212) can be allocated to one carrier, thus maximizing the available link margin. It should be appreciated that in the described system 100, a fourth RFT would be needed and can be implemented to provide a one-to-one matching of the signals 220 to the RFTs.

In the transmit chain, if the weather 212 that would negatively affect the transmit signal 210 at the antenna 106 is expected or present, the uplink selector 204 can instead route one or more of the uplink subchannels 231 via the antenna 104 or the antenna 102 instead of using the antenna 106.

In such an example, the uplink selector 204 can communicate digital IF signals (e.g., the uplink subchannels 231) to the RFT 112 or the RFT 114 instead of the RFT 116 due to the weather 212. This switching can also be accomplished in response to equipment failure, earthquake, strike, conflict, etc. or other reason that makes the site unavailable for uplink. However, because the uplink signal 230 has the four exemplary uplink subchannels 231, certain intermodulations may still occur if transmitted via the same antenna. The intermodulation can diminish the fidelity of one or more of the uplink subchannels 231 and degrade signal quality upon arrival at the destination ground station, for example. In order to reduce the instance of intermodulation of the uplink subchannels 231, the transmit power may be reduced. Reducing transmit power can cause degraded signal quality over the transmit path to the satellite 110 and reduce the amount of data throughput through the link. A direct impact of lower amplifier power is lower SNR of the received signal, which also means the signal can carry less data. In some examples, the backoff may be from about 2 dB to 10 db. In some examples the backoff may be more than 10 dB.

Alternatively, the RFT 116 and the antenna 106 can transmit one constituent signal or downlink subchannel (e.g., the signal 221d) at minimum back-off, for example. This provides additional rain fade margin. As used herein rain fade margin can describe the power required to overcome signal degradation caused by increased atmospheric absorption arising from certain events in the weather 212. For example, in operations using the Ka and Ku band (for example, above 10 GHz), the wavelength of the associated signals is smaller and thus affected by moisture in the atmosphere. Increased transmit power can compensate for these additional radio link losses.

In the transmit chain, digital IF form of the transmit data can be received at the selected RFT 112, 114, or 116 and the associated signal modifier 216. The signal modifiers 216 can then transform the digital IF signals back into analog IF signals, carrying the transmit data 210. In some embodiments, the analog IF signals produced by the signal modifiers 216 are functionally the same signals as those produced at the hub 202, modulating the transmit data 210.

The signal modifiers 216 can each be coupled to an upconverter 218 (labeled Up-C 218a, Up-C 218b, Up-C 218c). The upconverters 218 can upsample, or otherwise upconvert the analog IF signals from the signal modifiers 216 to the actual or operational transmit frequency for the antennas 102, 104, 106. The upconverters 218 can be coupled to PAs 212 (shown as PAs 212a, 212b, 212c) for amplification prior to transmission from the antennas 102, 104, 106.

FIG. 3 is a functional block diagram of components of a communication device that may be employed within the communication system of FIG. 1 and FIG. 2. The RFTs 112, 114, 116 and the associated antennas of FIG. 1 and FIG. 2 can be implemented using the depicted communication device 300. In some embodiments portions of the communication device 300 not already described in connection with the SPS 150 may be combined to provide the signal combining (e.g., site diversity) and transmit power management described herein.

The communication device (“device”) 300 may include a processor 304 which controls operation of the communication device 300. The processor 304 may also be referred to as a central processing unit (CPU). The communication device 300 may further include a memory 306 operably connected to the processor 304, which may include both read-only memory (ROM) and random access memory (RAM), providing instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein. The memory 306 can be implemented as the memory 153 where the communication device 300 is implemented as the SPS 150.

When the communication device 300 is implemented or used as a receiving node or ground station, the processor 304 may be configured to process information from of a plurality of different signal types. In such an embodiment, the communication device 300 may be implemented as the ground station 140, 142, 144 for example, and configured to receive the downlink subchannels 221 or transmit the uplink subchannels 231. The device 300 implemented as the SPS 150 can combine digital forms of the received downlink subchannels 221 received from the antennas 102, 104, 106 and transmit the uplink subchannels 231 from the antennas 102, 104, 106. Thus, the processor 304 (alone or in combination with the processor 152) may be configured to determine signal or channel conditions of each of the downlink subchannels 221 and determine, based on the channel conditions, from which RFT to transmit the uplink subchannels 231.

The processor 304 may have one or more modules 302 configured to implement various processes or methods in certain switching operations during transmission or signal combination operations during reception. The modules 302 may perform the tasks of the hub 202, the uplink selector 204 and/or the combining unit 208.

The processor 304 may further include one or more adaptive equalizers (not shown). The adaptive equalizers may be configured to estimate and characterize incoming signals in the time domain for interference reduction and signal separation.

The processor 304 may comprise or be a component of a processing system implemented with one or more processors 304. The one or more processors 304 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processor 304 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors 304, cause the processing system to perform the various functions described herein.

The communication device 300 may also include a transmitter 310 and a receiver 312 to allow transmission and reception of data between the communication device 300 and a remote location. For example, such communications may occur between the ground stations 140, 142, 144. The transmitter 310 and receiver 312 may be combined into a transceiver 314 at an RFT. An antenna 316 may be attached to a housing 308 and electrically coupled to the transceiver 314 or to the transmitter 310 and the receiver 312 independently. The communication device 300 may also include (not shown) multiple transmitters, multiple receivers, multiple transceivers, and/or multiple antennas. In some embodiments, the transmitter 310, the receiver 312, and the antenna 316 can also perform some or all of the functions associated with the antennas 102, 104, 106, 230 for example.

The communication device 300 may also include a signal detector 318 that may be used in an effort to detect and quantify the level of signals received by the transceiver 314. The signal detector 318 may detect such signals as frequency, bandwidth, symbol rate, total energy, energy per symbol, power spectral density and other signal characteristics. The signal detector 318 may also be include a “windowing module,” and may further be configured to process incoming data (e.g., the signals 220) ensuring that the processor 304 is receiving a correct bandwidth-limited portion of a wireless communication spectrum in use. As a non-limiting example, certain transmissions to and from a ground station 140, 142, 144 can incur certain time and frequency variations by the time the transmissions are received at the satellite 110 and rerouted to the ground station 144. Such variations may be due to Doppler shift and distance traveled, among other factors. Accordingly, the signal detector 318 (or windowing module) may correct the incoming signal(s) 136 for bandwidth and center frequency to ensure the processor 304 received the correct portion of the spectrum including the transmit signal 210.

The communication device 300 may also include a digital signal processor (DSP) 320 for use in processing signals. The DSP 320 may be configured to generate a data unit for transmission. The DSP 320 may further cooperate with the signal detector 318 and the processor 304 to determine certain characteristics of the constituent signals 220. The DSP 320 can further have one or more analog to digital converters (A2D), one or more digital to analog converters (D2A), downconverters 222, upconverters 218, signal modifiers 203, 216 and other components required for the source selection (e.g., the uplink selector 204), switching (e.g., the combining unit 208), decoding, and demodulating, for example. In some embodiments, the signal detector 318 and the DSP 320 may be contained within the processor 304.

The communication device 300 may further comprise a user interface 322. The user interface 322 may comprise a keypad, a microphone, a speaker, and/or a display. The user interface 322 may include any element or component that conveys information to a user of the communication device 300 and/or receives input from the user.

The various components of the communication device 300 described herein may be coupled together by a bus system 326. The bus system 326 may include a data bus, for example, as well as a power bus, a control signal bus, and a status signal bus in addition to the data bus. Those of skill in the art will appreciate the components of the communication device 300 may be coupled together or accept or provide inputs to each other using some other mechanism. The bus system 326 can further couple the communication device to the terrestrial network 148, for example, coupling a first communication device 300 (e.g. the ground station 142) to one or more second communication devices 300 (e.g., the ground station 144).

Although a number of separate components are illustrated in FIG. 3, one or more of the components may be combined or commonly implemented. For example, the processor 304 may be used to implement not only the functionality described above with respect to the processor 304, but also to implement the functionality described above with respect to the signal detector 318 and/or the DSP 320. Further, each of the components illustrated in FIG. 3 may be implemented using a plurality of separate elements. Furthermore, the processor 304 (or one or more processors) may be used to implement any of the components, modules, circuits, or the like described herein, or each may be implemented using a plurality of separate elements.

Embodiments of processes for satellite communication using site diversity and transmit power management will now be described in further detail. It should be understood that the described processes may be embodied in one or more software modules that are executed by one or more hardware processors, as discussed above (e.g., the processor 152, the processor 304), which may be executed wholly by processor(s) of the device 300, wholly by processor(s) of the SPS 150, or may be distributed across the RFTs 112, 114, 116 and the system 100 such that some portions or modules of the application are executed by the processor 152 and other portions or modules of the application are executed by the processor 304. The described process may be implemented as instructions represented in source code, object code, and/or machine code. These instructions may be executed directly by the hardware processor(s), or alternatively, may be executed by a virtual machine operating between the object code and the hardware processors. In addition, the disclosed application may be built upon or interfaced with one or more existing systems.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

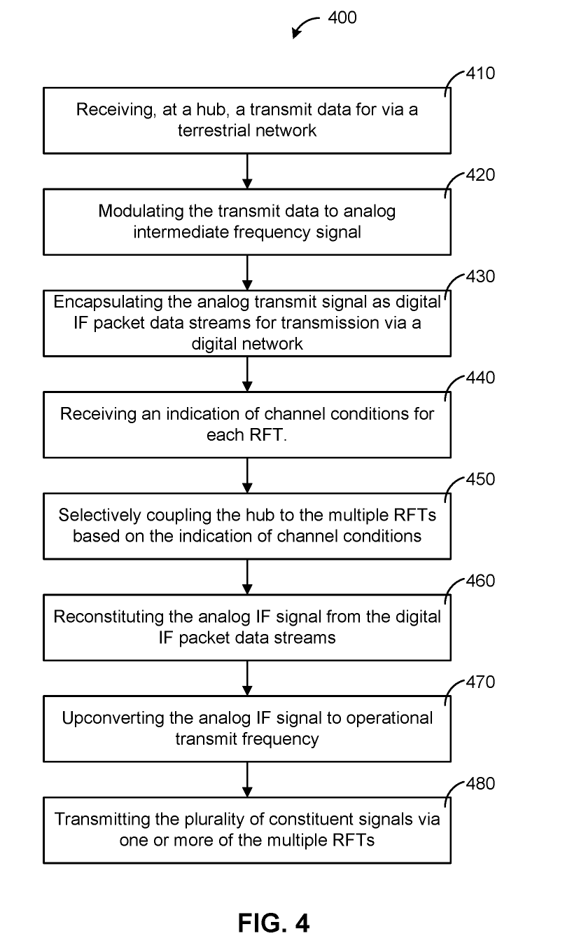

FIG. 4 is a flowchart of a method for satellite communication using the system of FIG. 2. A method 400 can begin at block 410. The various functions or steps of the method 400 can be executed by the processor 152 (of the SPS 150) independently or cooperatively with the processor 304 of the device 300.

At bock 410, the SPS 150 can receive the transmit data 210 at the hub 202 via the terrestrial network 148, for example. The transmit data 210 can be any information intended for transmission via the satellite 110. The transmit data 210 can arrive at the SPS 150 as packet data or IP data, for example.

At block 420, the SPS 150 can transform the transmit data into one or more modulated analog signals (e.g., the constituent signals 220) at the hub 202. As noted above, the hub 202 can have one or more modems (e.g., the modem 324) to modulate and demodulate one or more data streams into signals, as needed. In some embodiments, the transmit data can be modulated to an L-band analog signal or other IF band, for example.

At block 430, the SPS 150 can digitize or encapsulate the modulated analog signals (e.g., the modulated transmit data 210) as digital packets or packetized signal data streams (e.g., IP packets) at the signal modifier 203. These packetized signal data streams can be transmitted to one or more of the RFTs via the terrestrial network 148. This is referred to herein as digital IF. The use of digital IF allows for faster switching of data with minimal loss and increased efficiency.

At block 440, the processor 152, or the uplink selector 204, can receive information about downlink signal quality from the combining unit 208. In particular, the combining unit 208 (e.g., the processor 152) can determine signal quality from each coupled RFT. The uplink selector 204 can then route the individual (packetized) signal data streams (of the modulated transmit data 210) to the most efficient or most appropriate RFT (e.g., the RFTs 112, 114, 116) for transmission to the satellite. This routing can be based on commands from the processor 152. In some embodiments, the quality of the downlink signals 220 or the downlink subchannels 221 received at the various antennas 102, 104, 106 can provide an indication of weather conditions surrounding the antennas 102, 104, 106 or other conditions affecting transmission or signal quality. This information can allow the uplink selector 204 (e.g., the processor 152, 304) to avoid transmitting from a degraded antenna and appropriately or more efficiently route the signals 220.

At block 450, the SPS 150 can use the uplink selector 204 to selectively couple the SPS 150 to one or more of the RFTs 112, 114, 116 and their respective antennas 102, 104, 106 based on the signal information received at block 440. The packetized signal data streams for the transmit data subchannels 211 can then be communicated to the RFTs 112, 114, 116 via the terrestrial network 148. This can maximize the network performance by selectively routing signals to RFT/antenna pairs with better performance. This can also maximize data throughput, ensuring priority channels maintain their data rates.

At block 460 the RFTs 112, 114, 116 can reconstitute the modulated analog (IF) signals carrying the transmit data 210 from the packetized signal data streams at the signal modifiers 216.

At block 470, the reconstructed analog signals can then be upconverted to their operational transmit frequency as the uplink signal 230 (e.g., the uplink subchannels 231). The uplink subchannels 231 can then be amplified by the PAs 212 prior to transmission.

At block 480, the uplink subchannels 231 can be transmitted from the selected antennas 102, 104, 106 to the satellite 110.

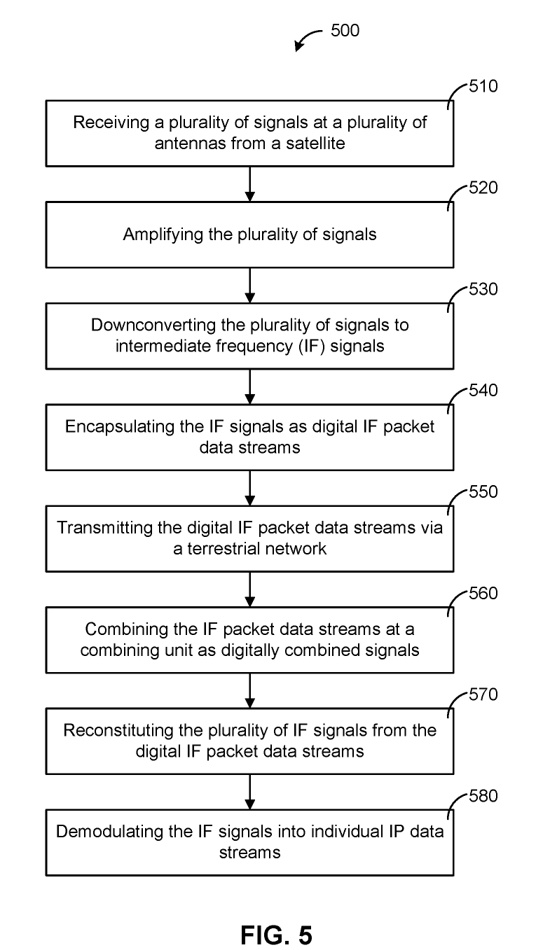

FIG. 5 is a flowchart of a method for satellite communication using the system of FIG. 2. A method 500 can begin at block 510. The various functions of the method 500 can be executed by the CPU 152 (of the SPS 150) independently or cooperatively with the processor 304 of the device 300.

At block 510, the antennas 102, 104, 106 can receive the downlink subchannels 221 from the satellite 110. In some embodiments, each of the antennas 102, 104, 106 and their respective RFTs 112, 114, 116 can all receive all four of the downlink subchannels 221. In some other embodiments, not all of the downlink subchannels 221 may be received at all of the antennas 102, 104, 106.

At block 520, the received downlink subchannels 221 can be amplified at the LNAs 214.

At block 520, each of the amplified downlink subchannels 221 can be downconverted from the operational transmit frequency from the satellite to IF analog signals.

At block 540, the signal modifiers 216 can packetize the IF analog signals as digital IF packet data streams.

At block 550, the digital IF data streams can be transmitted via the terrestrial network 148. The digital IF form of the downlink subchannels 221 can be transmitted easily through such a packet-switched network.

At block 560, the combining unit 208 can digitally combine all of the digital IF packet data streams. The combining unit 208 can measure the incoming digitized signals, measure various characteristics (e.g., frequency, amplitude, phase, etc.) align them in frequency and phase, and digitally combine them to maximize the combined signal SNR and thus maximize the data throughput. In some embodiments, this information can be provided to the uplink selector 204 and the processor 152, for example, to facilitate the method 400.

At block 570, the signal modifiers 203 can reconstitute the analog IF signals from the digital IF packet data streams.

At block 580, the individual IF signals can be demodulated and transmitted as individual IP data streams via the backbone 205 to their respective customers. In some embodiments, the method 500 can the downconverters 214 may not be required prior to digitization may with faster digitizers.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The processes described herein may be implemented in hardware, software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry, as described in connection with FIG. 2. and FIG. 3. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Although embodiments of the invention are described above for particular embodiment, many variations of the invention are possible. For example, the numbers of various components may be increased or decreased, modules and steps that determine a supply voltage may be modified to determine a frequency, another system parameter, or a combination of parameters. Additionally, features of the various embodiments may be combined in combinations that differ from those described above.

Those of skill will appreciate that the various illustrative blocks and modules described in connection with the embodiment disclosed herein can be implemented in various forms. Some blocks and modules have been described above generally in terms of their functionality. How such functionality is implemented depends upon the design constraints imposed on an overall system. Skilled persons can implement the described functionality in varying ways for each particular application, but such implementation decisions should not be interpreted as causing a departure from the scope of the invention. In addition, the grouping of functions within a module or block is for ease of description. Specific functions or steps can be moved from one module or block or distributed across to modules or blocks without departing from the invention.

The above description of the disclosed embodiment is provided to enable any person skilled in the art to make or use the invention. Various modifications to these embodiments will be readily apparent to those skilled in the art, and the generic principles described herein can be applied to other embodiment without departing from the spirit or scope of the invention. Thus, it is to be understood that the description and drawings presented herein represent a presently preferred implementation of the invention and are therefore representative of the subject matter which is broadly contemplated by the present invention. It is further understood that the scope of the present invention fully encompasses other embodiment that may become obvious to those skilled in the art and that the scope of the present invention is accordingly limited by nothing other than the appended claims.

What is claimed is:

1. A method for satellite communications in a system having multiple radio frequency terminals (RFTs), each RFT of the multiple RFTs being associated with an antenna and a satellite ground station, the method comprising:
modulating, by one or more modems at a signal processing site (SPS), transmit data as intermediate frequency (IF) signals, each IF signal being a modulated analog signal, the transmit data comprising a plurality of internet protocol (IP) data streams for transmission via a satellite;
receiving an indication of channel conditions for the antenna at each RFT of the multiple RFTs;
selectively coupling, by an uplink selector at the SPS, the SPS to one or more selected RFTs of the multiple RFTs via a digital network based on the indication of channel conditions;
upconverting the IF signals to an operational transmit frequency as uplink subchannels; and
transmitting the uplink subchannels to a satellite from the antenna of the one or more selected RFTs.

2. The method of claim 1 further comprising:
encapsulating, at a signal modifier of the SPS, each of the IF signals as a digital IF data packet stream of multiple IF packet data streams before the selectively coupling; and
reconstituting the IF signals from the digital IF packet data streams before the upconverting.

3. The method of claim 1 further comprising:
receiving one or more downlink subchannels different from the uplink subchannels at each of the multiple RFTs via the respective antenna from a satellite;
determining at a combining unit of the SPS coupled to the multiple RFTs as signal quality of each of the downlink subchannels.

4. The method of claim 1 further comprising receiving the indication of channel conditions from a combining unit in a receive chain of the SPS.

5. The method of claim 1 further comprising receiving, at the SPS, the transmit data via a terrestrial network.

6. The method of claim 1, wherein the indication of channel conditions for the antenna at each RFT is based on downlink signal quality of the downlink subchannels.

7. The method of claim 1, wherein the indication of channel conditions for the antenna at each RFT is based at least in part on a data throughput of each RFT due to weather surrounding each RFT.

8. A system for satellite communications comprising:
a plurality of antennas for communication with a satellite, each antenna being coupled to a radio frequency terminal (RFT);
a plurality of RFTs, each RFT of the plurality of RFTs communicatively coupled to an antenna of the plurality of antennas; and
a signal processing site (SPS) having,
an uplink selector communicatively coupled to the plurality of RFTs in a transmit chain,
a combining unit communicatively coupled to the plurality of RFTs in a receive chain, and
one or more processors communicatively coupled to the uplink selector and the combining unit, the SPS being configured to,
receive a plurality of receive downlink signals from a satellite via the plurality of antennas,
combine the plurality of downlink signals at the combining unit to determine a link quality for each downlink signal of the plurality of downlink signals;
receive transmit data transmission via the transmit chain to the satellite, the transmit data having multiple IP data streams,
determine channel conditions for the antenna at each RFT of the multiple RFTs,
selectively couple the uplink selector to selected RFTs of the plurality of RFTs by the uplink selector based on the channel conditions, and
transmit the transmit data uplink signals via the selected RFTs.

9. The system of claim 8 wherein the SPS is further configured to
modulate, by one or more modems at the SPS, the transmit data as intermediate frequency (IF) signals for each IP data stream, each IF signal being a modulated analog signal, the transmit data having a plurality of internet protocol (IP) data streams for transmission via the satellite.

10. The system of claim 8 wherein the SPS is further configured to modulate, at one or more modems of the SPS, the multiple IP data streams as multiple IF signals, each IF signal of the multiple IF signals being an analog signal.

11. The system of claim 10, wherein each RFT further comprises an upconverter in the transmit chain, configured to upconvert the IF signals to an operational transmit frequency as the uplink signals,
wherein each RFT is further configured to transmit the uplink signals from the antenna of the one or more selected RFTs.

12. The system of claim 11 further comprising:
a first signal modifier of the SPS configured to encapsulate each of the IF signals as a digital IF data packet stream of multiple IF packet data streams before the selectively coupling; and
a second signal modifier of the RFT configured to reconstitute the IF signals from the digital IF packet data streams in the transmit chain before the upconverting.

13. The system of claim 10 wherein each RFT further comprises a downconverter in the receive chain, configured to downconvert the plurality of downlink signals to IF for transmission to the SPS,
wherein each RFT is further configured to receive one or more downlink signals of the plurality of downlink signals via the antenna.

14. The system of claim 8 wherein the SPS is further configured to receive the transmit data via a terrestrial network.

15. The system of claim 8 wherein the channel conditions for the antenna at each RFT is based at least in part on a data throughput of each RFT in the receive chain due to weather surrounding each RFT.

16. A non-transitory computer readable medium in a satellite communications system having multiple radio frequency terminals (RFTs), each RFT of the multiple RFTs being associated with an antenna and a satellite ground station, the non-transitory computer readable medium comprising instructions that when executed by one or more processors cause the satellite communication system to:
modulate, at one or more modems at a signal processing site (SPS), transmit data as intermediate frequency (IF) signals, each IF signal being a modulated analog signal, the transmit data comprising a plurality of internet protocol (IP) data streams for transmission via a satellite;
receive an indication of channel conditions for the antenna at each RFT of the multiple RFTs;
selectively couple the SPS to one or more selected RFTs of the multiple RFTs via a digital network based on the indication of channel conditions;
upconvert the IF signals to an operational transmit frequency as uplink subchannels; and
transmit the uplink subchannels to a satellite from the antenna of the one or more selected RFTs.

17. The non-transitory computer readable medium of claim 16 further comprising instructions causing the satellite communication system to:
encapsulate, at a signal modifier of the SPS, each of the IF signals as a digital IF data packet stream of multiple IF packet data streams before the selectively coupling; and
reconstitute the IF signals from the digital IF packet data streams before the upconverting.

18. The non-transitory computer readable medium of claim 16 further comprising instructions causing the satellite communication system to:
receive one or more downlink subchannels different from the uplink subchannels at each of the multiple RFTs via the respective antenna from a satellite;
determine at a combining unit of the SPS coupled to the multiple RFTs as signal quality of each of the downlink subchannels.

19. The non-transitory computer readable medium of claim 16 further comprising instructions causing the satellite communication system to receive the indication of channel conditions from a combining unit in a receive chain of the SPS.

20. The non-transitory computer readable medium of claim 16 further comprising instructions causing the satellite communication system to receive the transmit data via a terrestrial network.
